(19) United States
(12) Patent Application Publication
(10) Pub. No.: US 2010/0007450 A1
(43) Pub. Date: Jan. 14, 2010

(54) Tone Wheel

(75) Inventor: Hideo Mizuta, Okayama (JP)

Correspondence Address: BACON & THOMAS, PLLC, 625 SLATERS LANE, FOURTH FLOOR, ALEXANDRIA, VA, 22314-1176, US

(73) Assignee: Uchiyama Manufacturing Corp.

(21) Appl. No.: 12/087,677

(22) PCT Filed: Dec. 27, 2006
(86) PCT No.: PCT/JP2006/326058

§ 371 Date: Apr. 3, 2009

(30) Foreign Application Priority Data
Jan. 11, 2006 (JP) 2006-003584

(51) Int. Cl. H01F 7/02

(52) U.S. Cl. 335/302

(57) ABSTRACT

A tone wheel constituting a rotation detection magnetic encoder in combination with a magnetic sensor fixed onto a stationary side member, the tone wheel comprising a metal reinforcing ring fitted in a rotary side member and a circular multipolar magnet fixed to the metal reinforcing ring. the circular multipolar magnet is made of a plastic magnet of a circular resin molded product which contains a magnetic powder therein and is magnetized with a number of S and N poles alternatively along its circumference; the circular multipolar magnet is fixed to a surface of the metal reinforcing ring opposed to the magnetic sensor with an adhesive; and a restraint portion is provided at a part of the portion wherein the circular multipolar magnet is fixed to the metal reinforcing ring, thereby fixation of the circular multipolar magnet to the metal reinforcing ring is reinforced and depart of the circular multipolar magnet from the metal reinforcing ring is prevented.

### TECHNICAL FIELD

The present invention relates to a tone wheel constituting a magnetic encoder for detecting the rotation number of the wheel of automobile and more particularly relates to a tone wheel provided so as to detect the rotation number of the wheel to be applied to an antilock brake system or a traction control system of automobiles.

### BACKGROUND ART

The wheel of automobile is sometimes equipped with a magnetic encoder for detecting the rotation number. Such a magnetic encoder may be comprised of a tone wheel constituted with a rotating member of the wheel like a slinger (metal reinforcing ring) of a seal ring of a wheel bearing system and a magnetic sensor which is fixed on the automobile body (stationary member side) and is provided so as to closely confront the surface of the tone wheel. On the other hand, a tone wheel may be employed such that it is fitted in and fixed to the rotary side member via a metal reinforcing ring other than the seal ring and confronts the magnetic sensor of the automobile body. Such a tone wheel is comprised of a metal reinforcing ring which is mounted to the rotary side member to be integrally fitted and a circular multipolar magnet fixed to the metal reinforcing ring. The circular multipolar magnet may be a circular rubber magnet which is constructed such that a circular magnetic rubber sheet containing a magnetic powder is magnetized with S poles and N poles formed alternately along the circumferential direction.

The above-mentioned tone wheel with a circular rubber magnet is manufactured such that a metal reinforcing ring is disposed in the cavity of a mold and an unvulcanized rubber material mixed with a magnetic powder is charged in the cavity to be vulcanized and integrally formed with the metal reinforcing ring, thereafter being magnetized. In this manner, the tone wheel with the circular rubber magnet is easily manufactured in a manner that the circular rubber magnet is integrated with the metal reinforcing ring by a vulcanized adhesion at the time of molding the rubber, so that such a tone wheel is often used as a magnetic encoder for detecting the rotation.

However, when the tone wheel is used for detecting the rotation of automobile wheel, it is apt to be used in a hard circumstances where foreign materials such as water, dirt, and dust scatter, so that such foreign materials are bit between the circular multipolar magnet being a circular rubber magnet and the magnetic sensor to make the surface to be detected of the circular multipolar magnet peeled off, damaged or broken, thereby deteriorating the detection accuracy of the magnetic sensor. The flash caused at the time of molding cannot be reused because the rubber material is vulcanized, thereby increasing waste material. Under such conditions, study and developments have been proceeded for using a plastic magnet for a tone wheel. The patent documents 1-3 disclose an embodiment of tone wheel (magnetic encoder) using a plastic magnet.

[Patent document 1] JP-2003-222150-A

[Patent document 2] JP-2004-138597-A

[Patent document 3] JP-2005-321307-A

### DISCLOSURE OF INVENTION

### Problems to be Solved in the Invention

A plastic magnet is not fixed to a metal reinforcing ring when it is simultaneously and integrally molded with the metal reinforcing ring, so that it is fixedly integrated with a predetermined portion of the metal reinforcing ring by means of adhesive after being molded in a predetermined circular shape. The above-mentioned patent documents 1-3 describe a circular plastic magnet (circular multipolar magnet) is fixed to the metal reinforcing ring by adhesive. However, the durability of the fixed and integrated portion with adhesive is not enough under the above-mentioned hard usage environment by fixing the plastic magnet at a predetermined portion of the metal reinforcing ring only with adhesive and the plastic magnet sometimes comes off the attached portion. Further if there is any gap between the attached boundary faces, water may come into the gap and the circular multipolar magnet may be broken when the invaded water is frozen. Therefore, a tone wheel with a plastic magnet does not have enough credibility at present and in fact it has not been widely used.

The present invention is proposed in view of the above-mentioned problems and its object is to provide a credible and new tone wheel using a plastic magnet.

### Means to Solve the Problems

According to the first aspect of the present invention, the tone wheel constitutes a rotation detection magnetic encoder in combination with a magnetic sensor fixed onto a stationary side member, the tone wheel comprising a metal reinforcing ring fitted in a rotary side member and a circular multipolar magnet fixed to the metal reinforcing ring, and is characterized in that the circular multipolar magnet is made of a plastic magnet of a circular resin molded product which contains a magnetic powder therein and is magnetized with a number of S and N poles alternatively along its circumference; the circular multipolar magnet is fixed to a surface of the metal reinforcing ring opposed to the magnetic sensor with an adhesive; and a restraint portion is provided at a part of the portion where the circular multipolar magnet is fixed to the metal reinforcing ring, thereby fixation of the circular multipolar magnet to the metal reinforcing ring is reinforced and depart of the circular multipolar magnet from the metal reinforcing ring is prevented.

The above-mentioned magnetic powder includes a ferrite powder, and a rare earth powder (NdFeB, SmFeN and the like), and a resin material (binder) for the plastic magnet includes thermoplastic resin such as nylon 6, nylon 12, nylon 66, nylon 6T, nylon 9T, polyphenylene sulfide (PPS) and the like. The magnetic powder is mixed in the resin material (additive and plasticizer are included if necessary) and molded as a resin composite product and the magnetic powder is included in the resin composite product at 70-95 weight percent. When the magnetic powder is contained less than 70 weight percent, a sufficient magnetic intensity is not obtained, but when it is contained over 95 weight percent, the binding intensity of the resin material as a binder becomes weak. Adhesive is preferably an epoxide-based adhesive having strong adhesion force, however, an elastic adhesive such as sealant and an elastomeric adhesive may be used. Specifically, the coefficient difference of thermal expansion is large between the metal reinforcing ring and the plastic magnet, so that there causes the thermal expansion difference between them under the environment where the temperature is significantly changed. If the elastic adhesive is used, the elasticity of the elastic adhesive layer may absorb the thermal expansion difference, thereby preventing peeling and breaking of the plastic magnet in advance.

According to the present invention, as mentioned in the second aspect, the restraint portion is constructed such that the circular multipolar magnet is fixed to the metal reinforcing ring by mutual pressed engagement. According to the third aspect of the present invention, the restraint portion is constructed such that the circular multipolar magnet is fixed to the metal reinforcing ring by mutual concavity and convexity engagement between the circular multipolar magnet and the metal reinforcing ring. Further according to the fourth aspect, the restraint portion is constructed such that the circular multipolar magnet is fixed to the metal reinforcing ring by mutual screwing engagement. Still further according the fifth aspect, the restraint portion is constructed such that the metal reinforcing ring is bent to the circular multipolar magnet side at its edge and thereby to restrain the edge of the circular multipolar magnet at the bent portion. It is preferable that, as mentioned in the sixth aspect of the invention, a protrusion part of an adhesive is further provided at an edge of the fixed part where the circular multipolar magnet is fixed to the metal reinforcing ring with adhesive.

### Effect of the Invention

According to the tone wheel of the first aspect of the present invention, the circular multipolar magnet is made of a plastic magnet, so that the surface to be detected is less damaged or peeled off when foreign materials are bit between the magnet and the magnetic sensor comparing with the case using a circular rubber magnet, thereby keeping measurement accuracy. Further, the circular multipolar magnet is fixedly integrated to the metal reinforcing ring by means of adhesive and a restraint portion as set forth in the second to the fifth aspects of the present invention is provided for a part of the fixed and integrated portion. The fixed and integrated condition by the adhesive is accordingly reinforced, so that the circular multipolar magnet does not come off when being used under a hard environment such as a detection part for the wheel rotation of automobile where foreign materials such as water, dirt and dust scatter, thereby achieving reliable rotation detection.

Further, the circular multipolar magnet is a plastic magnet made of a circular resin molded product including a magnetic powder magnetized by providing a number of S and N poles alternatively in the circumferential direction. As the result, the fluidity of the magnetic powder is high in the resin material when the magnetic powder is oriented by applying a magnetic filed at the time of molding (for example, injection molding), thereby achieving a high orientation efficiency and obtaining a circular multipolar magnet with superior magnetic characteristic by being magnetized after molding. The fluidity of the magnetic powder in an unvulcanized rubber material in case of a magnetic rubber is inferior than that of the resin material, so that much magnetic powder is required to increase the magnetic characteristic or the magnetic powder is required to be oriented by applying a strong magnetic field. In addition, if the resin binder is made of a thermoplastic resin, the flash produced at the time of molding can be reused, thereby contributing to improve the process yield of the used material.

Still further, when there exist protrusions of the adhesive at an end of the fixed and integrated portion of the circular multipolar magnet and the metal reinforcing ring by means of adhesive as set forth in the sixth aspect of the present invention, water is prevented from coming in the adhesion boundary surfaces by the existence of the protrusions, thereby eliminating breakage of the circular multipolar magnet when the invaded water is frozen.

### BRIEF DESCRIPTION OF DRAWINGS

FIG. 1 is a vertical sectional view showing one embodiment of a bearing structure assembled with a tone wheel of the present invention.

FIG. 2 is an enlarged view of the area “X” in FIG. l.

FIG. 3 is a sectional view showing one example of a modified embodiment of the tone wheel of the present invention.

FIG. 4 is a sectional view showing other example of a modified embodiment of the tone wheel of the present invention.

FIG. 5 is a sectional view showing a still other example of a modified embodiment of the tone wheel of the present invention.

FIG. 6 is a sectional view of a tone wheel of other embodiment.

FIG. 7 is a sectional view of a tone wheel of still other embodiment.

### BEST MODE FOR CARRYING OUT THE INVENTION

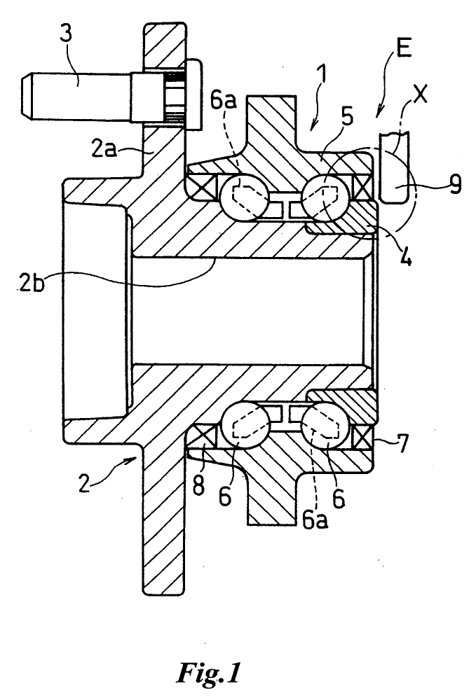

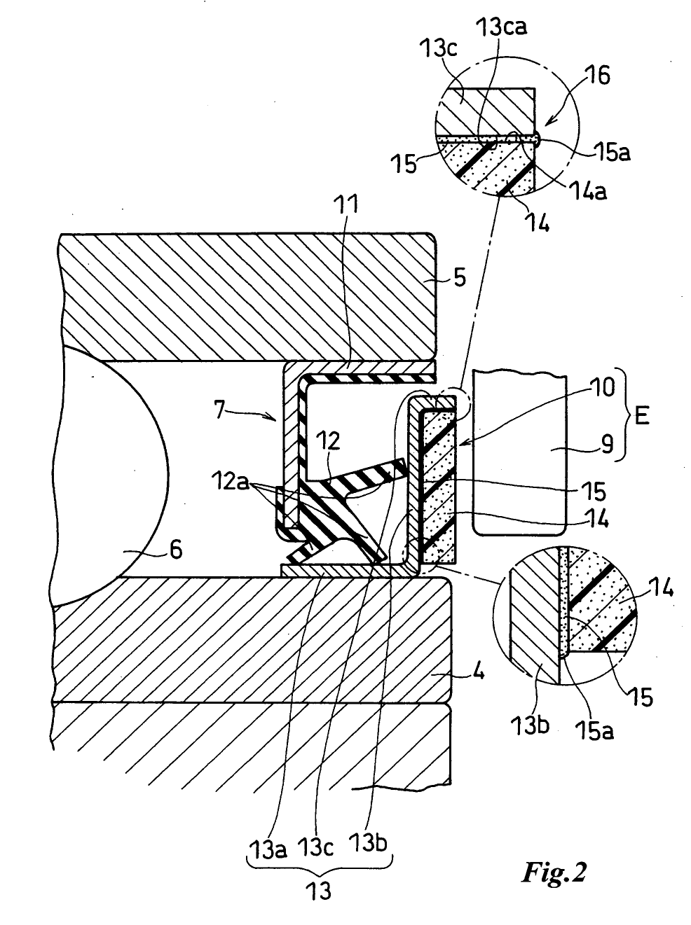

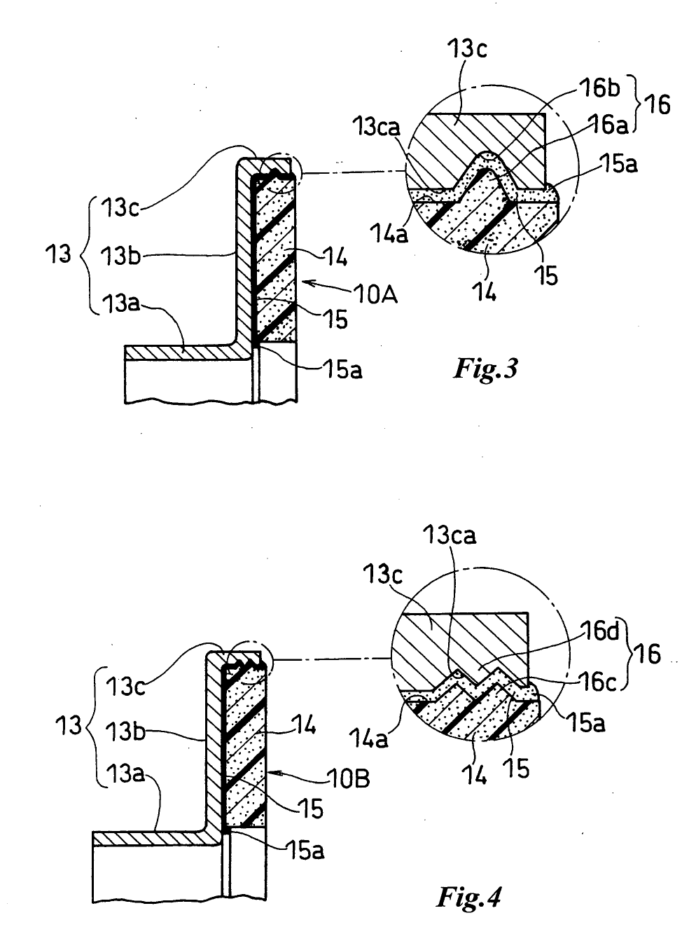

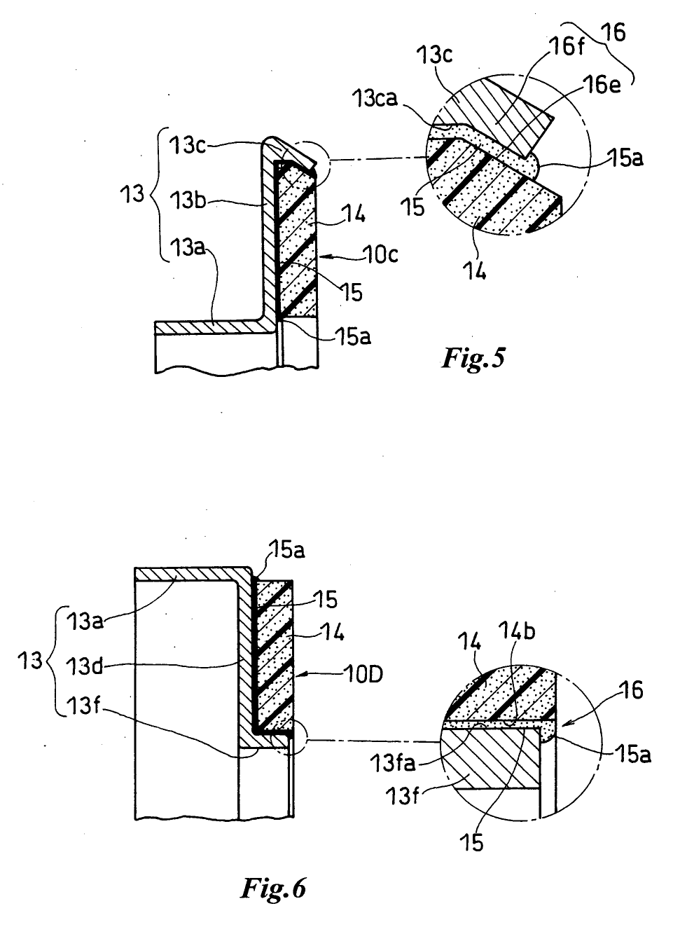

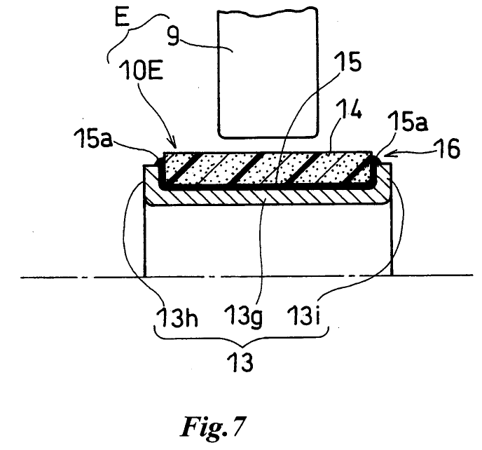

The best mode of the present invention is explained referring to the drawings. FIG. 1 is a vertical sectional view showing one embodiment of a bearing structure assembled with a tone wheel of the present invention, FIG. 2 is an enlarged view of the area “X” in FIG. 1, FIG. 3 is a sectional view showing one example of a modified embodiment of the tone wheel, FIG. 4 is a sectional view showing other example of a modified embodiment of the tone wheel, FIG. 5 is a sectional view showing a still other example of a modified embodiment of the tone wheel, FIG. 6 is a sectional view of a tone wheel of other embodiment, and FIG. 7 is a sectional view of a tone wheel of still other embodiment.

### Embodiment 1

FIG. 1 shows one example of a supporting structure of the vehicle wheel with a rolling bearing unit 1. A tire wheel (not shown) is fixed to a hub flange 2a of a hub 2 constituting an inner wheel (rotary side member) with a bolt 3. The drive shaft (not shown) is spline fitted in a spline hole 2b formed in the hub 2 and the rotary drive force of the drive shaft is transmitted to the tire wheel. The hub 2 constitutes an inner wheel together with an inner wheel member 4. An outer wheel (fixed side member) 5 is fixed to the vehicle suspension (not shown). Two rows of rolling elements (ball) 6 . . . are interposed between the outer wheel 5 and the inner wheel (hub 2 and inner wheel member 4) while being held with a retainer 6a. Seal rings 7, 8 are pressed and fitted between the outer wheel 5 and the inner wheel (hub 2 and inner wheel member 4) in order to prevent leakage of lubricant (such as grease) filled in a rolling portion of the rolling elements 6 . . . or to prevent entering of muddy water and dirt from outside. A magnetic sensor 9 is provided for the outer wheel 5 or a vehicle body (stationary side member) so as to face the outer surface of the seal ring 7 at the vehicle body side and constitutes a magnetic encoder E for detecting the rotation number of the tire wheel together with a tone wheel 10 mentioned later.

FIG. 2 shows an enlarged sectional view of the mounting portion of the seal ring 7 at the vehicle body side. The seal ring 7 comprises a tone wheel 10 to be externally and integrally fitted in the outer circumference (external peripheral face) of the inner wheel member 4, a core member 11 to be pressed and fitted into the inner circumference (inner peripheral face) of the outer wheel 5 and an elastic seal lip member 12, thereby constituting a pack seal type seal ring (referred to pack seal hereinafter). The elastic seal lip member 12 has a plurality of lips 12a . . . made of an elastic material such as rubber, of which tip ends elastically and slidably contact with the inner face (at rolling element 6 side) of the metal reinforcing ring (slinger) 13 constituting the tone wheel 10 and is fixed to the core member 11.

The tone wheel 10 is comprised of the metal reinforcing ring (slinger) 13 having a cylindrical portion 13a to be fitted and fixed in the external peripheral face of the inner wheel member 4, an outward brim portion 13b integrally formed at one end thereof and a large caliber cylindrical portion 13c concentrically extending in direction opposite to the cylindrical portion 13a at the outer circumferential end of the outward brim portion 13b. The tone wheel 10 is also comprised of a circular plastic magnet (circular multipolar magnet) 14 which is fixed and integrated to the outer face (at the vehicle body side) of the outward brim portion 13b and the inner peripheral face of the large caliber cylindrical portion 13c. The plastic magnet 14 is formed such that the above-mentioned binder resin including the aforesaid magnetic powder is molded in a circular shape and a plurality of N poles and S poles are alternately formed to be magnetized along the circumferential direction. Therefore, the magnetic change of the magnetized portion by rotation of the tone wheel 10 accompanied with the rotation of the hub 2 and the inner wheel member 4 is detected by the magnetic sensor 9 and the rotation (rotation speed and its direction) of the wheel is detected.

The external diameter of the plastic magnet 14 is designed to be substantially the same as or a little smaller than the inner diameter of the large caliber cylindrical portion 13c of the metal reinforcing ring 13 and the fixation and integration of the metal reinforcing ring 13 and the plastic magnet 14 by means of adhesive 15 are done via a press-fit (pressing and fitting) relation along the axial direction of the external peripheral face 14a of the plastic magnet 14 and the inner peripheral face 13ca of the large caliber cylindrical portion 13c. Namely, the press-fit relation of the external peripheral face 14a of the plastic magnet 14 and the inner peripheral face 13ca of the large caliber cylindrical portion 13c reinforces the fixation and integration of the metal reinforcing ring 13 and the plastic magnet 14 by means of the adhesive 15 and constitutes a restraint portion 16 for preventing coming-off of the plastic magnet 14 (drop-out into the axial direction, going-around in circles, or displacement of the outward brim portion 13b into the surface area by the centrifugal force). Accordingly, the fixing force is not sufficient by fixing and integrating the metal reinforcing ring 13 and the plastic magnet 14 only with the adhesive 15 for rotation detection at the high speed rotating portion like the wheels of automobile, however, by further providing the restraint portion 16, the fixing force is increased and the coming-off of the plastic magnet 14 is prevented. Specifically the adhesive 15 is used also at the press-fit portion, so that the adhesive force of the adhesive 15 and the restraint force of the press-fit relation achieve multiple effect, thereby accomplishing a strong fixation and integration. Thereby, the characteristic of the plastic magnet 14 is utilized and the adequacy of rotation detection for automobile vehicle is increased.

When the adhesive is applied on the plastic magnet 14 or the metal reinforcing ring 13 for fixing and integrating them so as to provide protrusion parts 15a, 15a of adhesive at the end of the fixed and integrated portion. By providing such protrusions 15a, 15a of the adhesive, water does not enter into the attached boundary surfaces, thereby effectively preventing breakage of the plastic magnet 14 when the entered water gets frozen. The attaching and fixing surface of the plastic magnet 14 and the metal reinforcing ring 13 by means of the adhesive 15 is set to have the surface roughness greater than or equal to Ra0.8. The attaching and fixing strength by adhesive is more increased by such a surface roughness.

Although the tone wheel 10 is designed to be one constituting member of the pack seal 7 in this embodiment, the magnetic encoder E may be constructed such that the tone wheel is fitted in the rotary side member as a single member and the magnetic sensor 9 is arranged to confront the tone wheel 10. FIG. 1 and FIG. 2 show an example of a bearing unit 1 of the driving wheel in which the inner wheel is rotated. However, it goes without saying that the present invention can be applied to the bearing unit of a driven wheel when the outer wheel is rotated. In this case, the tone wheel 10 is fitted and fixed in the outer wheel being a rotary side member.

The tone wheels 10A-10C in FIG. 3 to FIG. 5 show the modifications of the above-mentioned embodiment, in which the configuration of the restraint portion 16 is different in each embodiment. Namely, according to the tone wheel 10A in FIG. 3, a protrusion strip or a noncontiguous projection (convex portion) 16a is formed along the circumferential direction at the external diameter surface 14a of the plastic-magnet 14, and a circular groove or a noncontiguous hole with bottom (concave portion) 16b is formed at the inner peripheral face 13ca of the large caliber cylindrical portion 13c of the metal reinforcing ring 13 so as to be fitted in the convex portion 16a, thereby constituting the restraint portion 16 by the fitting engagement of the convex portion 16a and the concave portion 16b. The adhesive 15 is provided at the fitting portion of the convex portion 16a and the concave portion 16b and the fixing force of the plastic magnet 14 to the metal reinforcing ring 13 is strengthened by the fixation and integration by the adhesive 15 using the restraint portion 16 together, thereby preventing coming-off of the plastic magnet 14. The concave portion 16b may be a through hole or a cutout, however it is desirably a groove or a hole with bottom as mentioned above because the bared portion of the adhesive 15 is increased.

In the tone wheel 10B in FIG. 4, a male screw portion 16c is formed at the external peripheral face 14a of the plastic magnet 14 and a female portion 16d is formed at the inner peripheral face 13ca of the large caliber cylindrical portion 13c of the metal reinforcing ring 13 so as to be screwed with the male screw portion 16c, thereby constituting the restraint portion 16 by the screwing engagement of the male screw portion 16c and the female screw portion 16d. The screwed portion of the male screw portion 16c and the female screw portion 16d is provided with the adhesive 15 and the fixing force of the plastic magnet 14 to the metal reinforcing ring 13 is strengthened by the fixation and integration by the adhesive 15 using the restraint portion 16 together, thereby preventing coming-off of the plastic magnet 14.

Further according to the tone wheel 10C in FIG. 5, a tapered portion 16e is provided at the external peripheral face 14a of the plastic magnet 14 and a bent tapered portion (bent portion) 16f which is bent into the plastic magnetic 14 side is formed at the inner peripheral face 13ca of the large caliber cylindrical portion 13c of the metal reinforcing ring 13 so as to meet the tapered portion 16e, thereby constituting the restraint portion 16 capable of fettering the end of the plastic magnet 14 by the aligned and fixed relation of the both tapered portions 16e, 16f. The aligned and fixed portion of the both bent portions 16e, 16f is provided with the adhesive 15 and the fixing force of the plastic magnet 14 to the metal reinforcing ring 13 is strengthened by the fixation and integration by the adhesive 15 using the restraint portion 16 together, thereby preventing coming-off of the plastic magnet 14. In this embodiment, it is desirable that the angular tip end of the bent tapered portion 16f does not project from the magnetic sensor side of the plastic magnet 14. By such a configuration where it does not project, in case of magnetizing the metal reinforcing ring 13 and the plastic magnet 14 after being integrated, the tapered portion 16f does not become an obstacle when a magnetizing yoke goes close to the plastic magnet 14 and the sensor gap can be reduced when the magnetic encoder is constituted by providing the magnetic sensor.

FIG. 7 of the patent document 2 shows an embodiment in which the plastic magnet is fixed by caulking the edge of the metal reinforcing ring. However, it does not intend to provide an adhesive at the caulking portion, therefore, the multiple effect of the fixing force of the adhesive 15 and the restraining force of the restraint portion 16 cannot be expected. Further, there is a fear that the plastic magnet is damaged to cause breakage and deformation at the time of caulking in case of caulking structure. However, in the present invention, there is no such a fear and concern, thereby facilitating manufacture. The other constructions of FIG. 3-FIG. 5 are the same as those of FIG. 1 and FIG. 2, the common members are allotted with the same reference numerals and their explanations are omitted here. The tone wheels 10A-10C may be a constitution member of the pack seal 7 as shown in FIG. 1 and FIG. 2, and otherwise they may be fitted in the rotary side member as a single member, or may be used for detecting the rotation of a driven wheel when the outer wheel is rotated, as mentioned above.

### Embodiment 2

FIG. 6 shows other embodiment of a tone wheel of the present invention and the configuration of the metal reinforcing ring 13 of the tone wheel 10D is different from the above-mentioned embodiments. The metal reinforcing ring 13 comprises a cylindrical portion 13a to be fitted and fixed into the external peripheral face or inner peripheral face of the rotary side member, an inward brim portion 13d integrally formed at one end, and a small caliber cylindrical portion 13f concentrically extending from the direction opposite to the cylindrical portion 13a at the inner circumferential edge of the inward brim portion 13d. The inner diameter of the plastic magnet 14 is designed to be substantially the same as or a little larger than the external diameter of the small caliber cylindrical portion 13f of the metal reinforcing ring 13 and the fixation and integration of the metal reinforcing ring 13 and the plastic magnet 14 by means of adhesive 15 are done via a press-fit relation along the axial direction of the inner peripheral face 14b of the plastic magnet 14 and the external peripheral face 13fa of the small caliber cylindrical portion 13f. Namely, the press-fit relation of the inner peripheral face 14b of the plastic magnet 14 and the inner peripheral face 13fa of the small caliber cylindrical portion 13f reinforces the fixation and integration of the metal reinforcing ring 13 and the plastic magnet 14 by means of the adhesive 15 and constitutes a restraint portion 16 for preventing coming-off of the plastic magnet 14.

The adhesive 15 is used at the press-fit portion as mentioned above, so that the adhesive force of the adhesive 15 and the restraint force by the press-fit relation achieve multiple effect, thereby accomplishing the strong fixation and integration of the metal reinforcing ring 13 and the plastic magnet 14. Thereby, the characteristic of the plastic magnet 14 is utilized and the adequacy of rotation detection for automobile vehicle is increased as mentioned above. There exist protrusions 15a, 15a of adhesive at the edge of the fixed and integrated portion of the metal reinforcing ring 13 and the plastic magnet 14. By providing such protrusions 15a, 15a of the adhesive, water does not enter into the attached boundary surfaces, thereby effectively preventing breakage of the plastic magnet 14 when the entered water gets frozen.

It goes without saying that the restraint portion as shown in FIG. 3-FIG. 5 may be used instead of the restraint portion 16 for the tone wheel 10D in this embodiment. Further, the tone wheel 10D may be designed to be one constituting member of the pack seal 7 as shown in FIG. 2, may be fitted in the rotary side member as a single member and may be used for detecting the rotation of a driven wheel when the outer wheel is rotated, as mentioned above. The other constructions are the same as mentioned above, so that the common members are allotted with the same reference numerals and their explanations are omitted here.

### Embodiment 3

FIG. 7 shows a still other embodiment 10E of a tone wheel of the present invention. The tone wheels 10, 10A-10D of the above-mentioned embodiments constitute an axial encoder, however the tone wheel 10E of this embodiment is different from them in that it constitutes a radial encoder. The metal reinforcing ring 13 comprises a cylindrical portion 13g to be fitted and fixed into the external peripheral face of the rotary side member, an outward brim portion 13h integrally formed at one end of the cylindrical portion 13g and a bent outward brim portion (bent portion) 13i formed at the other end of the cylindrical portion 13g thereafter. The plastic magnet 14 is a cylindrical body capable of externally fitting into the cylindrical portion 13g of the metal reinforcing ring 13. After it is externally fitted in the cylindrical portion 13g via the adhesive 15, the other end of the cylindrical portion 13g is bent outwardly to form the bent outward brim portion 13i, thereby forming the tone wheel 10E in which the metal reinforcing ring 13 and the plastic magnet 14 are fixed and integrated. The obtained tone wheel 10E constitutes a magnetic encoder E together with the magnetic sensor 9 which is closely confronted in its radial direction.

Thus formed bent outward brim portion 13i reinforces the fixation and integration of the metal reinforcing ring 13 and the plastic magnet 14 by means of the adhesive 15 and constitutes the restraint portion 16 for preventing coming-off (depart into the axial direction) of the plastic magnet 14. There exist protrusions 15a, 15a of adhesive at the edge of the fixed and integrated portion of the metal reinforcing ring 13 and the plastic magnet 14 by means of adhesive. Thereby the same effect as the tone wheel for the axial encoder as mentioned above can be obtained. Some of such a tone wheel for radial encoder may be fitted and fixed in the inner peripheral face of the rotary side member, however in this case, the cylindrical plastic magnet 14 is internally fitted in the metal reinforcing ring 13 and the metal reinforcing ring 13 has inner outward brim portions (the other one is bent afterward as mentioned above) at both edges respectively. Further in this embodiment, it goes without saying that the restraint portion 16 is executed by the mutual press-fit relation (pressed engagement) of the concavity and convexity (in either one of the cylindrical portion 13g, the outward brim portion 13h, and the bent outward brim portion 13i of the metal reinforcing ring 13) or the screwing relation (in the cylindrical portion 13g of the metal reinforcing ring 13).

The configuration of the restraint portion 16 is not limited to the one shown in the figure, but it may be, for example, the combination of the restraint portion 16 in FIG. 3 and the restraint portion 16 in FIG. 5 or may be the one shown in FIG. 5 with the concavity and convexity which is repeated in the circumferential direction on the aligned and united face. Further, the application example of the tone wheel of the present invention is not limited to the embodiments mentioned above and it goes without saying that it may be applied to the bearing or the bearing unit of a rotary member which requires to detect the rotation or to a rotary side member such as a rotary shaft (driving shaft) and the like as far as it constitutes a magnetic encoder together with a magnetic sensor provided at the stationary side member. Still further, the plastic magnet 14 is preferably magnetized after it is integrated with the metal reinforcing ring 13, however, it can be magnetized before such integration.

1. A tone wheel constituting a rotation detection magnetic encoder in combination with a magnetic sensor fixed onto a stationary side member, said tone wheel comprising a metal reinforcing ring fitted in a rotary side member and a circular multipolar magnet fixed to said metal reinforcing ring, wherein;
said circular multipolar magnet is made of a plastic magnet of a circular resin molded product which contains a magnetic powder therein and is magnetized with a number of S and N poles alternatively along its circumference;
said circular multipolar magnet is fixed to a surface of said metal reinforcing ring opposed to said magnetic sensor with an adhesive; and
a restraint portion is provided at a part of the portion where said circular multipolar magnet is fixed to said metal reinforcing ring, thereby fixation of said circular multipolar magnet to said metal reinforcing ring is reinforced and depart of said circular multipolar magnet from said metal reinforcing ring is prevented.

2. The tone wheel as set forth in claim 1, wherein said restraint portion is constructed such that said circular multipolar magnet is fixed to said metal reinforcing ring by mutual pressed engagement.

3. The tone wheel as set forth in claim 1, wherein said restraint portion is constructed such that said circular multipolar magnet is fixed to said metal reinforcing ring by mutual concavity and convexity engagement between said circular multipolar magnet and said metal reinforcing ring.

4. The tone wheel as set forth in claim 1, wherein said restraint portion is constructed such that said circular multipolar magnet is fixed to said metal reinforcing ring by mutual screwing engagement.

5. The tone wheel as set forth in claim 1, wherein said restraint portion is constructed such that said metal reinforcing ring is bent to said circular multipolar magnet side at its edge and thereby to restrain said edge of said circular multipolar magnet at the bent portion.

6. The tone wheel as set forth in claim 1, wherein a protrusion part of an adhesive is further provided at an edge of the fixed part where said circular multipolar magnet is fixed to said metal reinforcing ring with adhesive.

7. The tone wheel as set forth in claim 2, wherein a protrusion part of an adhesive is further provided at an edge of the fixed part where said circular multipolar magnet is fixed to said metal reinforcing ring with adhesive.

8. The tone wheel as set forth in claim 3, wherein a protrusion part of an adhesive is further provided at an edge of the fixed part where said circular multipolar magnet is fixed to said metal reinforcing ring with adhesive.

9. The tone wheel as set forth in claim 4, wherein a protrusion part of an adhesive is further provided at an edge of the fixed part where said circular multipolar magnet is fixed to said metal reinforcing ring with adhesive.

10. The tone wheel as set forth in claim 5, wherein a protrusion part of an adhesive is further provided at an edge of the fixed part where said circular multipolar magnet is fixed to said metal reinforcing ring with adhesive.
